(19) United States
(12) Patent Application Publication
(10) Pub. No.: US 2024/0080211 A1
(43) Pub. Date: Mar. 7, 2024

(54) MULTI-SIGNATURE-BASED DIGITAL ASSET MANAGEMENT METHOD AND DEVICE

(71) Applicant: Hwoain CHOI, Seoul (KR)

(72) Inventor: Hwoain CHOI, Seoul (KR)

(21) Appl. No.: 18/242,617

(22) Filed: Sep. 6, 2023

(30) Foreign Application Priority Data
Sep. 7, 2022 (KR) 10-2022-0113485

(51) Int. Cl. H04L 9/00; G06Q 40/08; H04L 9/08; H04L 9/32

(52) U.S. Cl. CPC H04L 9/50; G06Q 40/08; H04L 9/0825; H04L 9/3247

(57) ABSTRACT

Disclosed is a digital asset management method performed by a digital asset management device, the method including: processing, by a first terminal corresponding to the digital asset management device, a contract regarding a digital asset management service between a user, a service provider of the digital asset management service, and a third party through online connections; creating a contract account based on the contract; and registering a party account corresponding to the first terminal among party accounts, which are created based on cryptographic keys managed by the first, second, and third terminals, onto the contract account.

### CROSS-REFERENCE TO RELATED APPLICATION

The application claims priority from Korean Patent Application No. 10-2022-0113485 filed on Sep. 7, 2022 in the Korean Intellectual Property Office, and all the benefits accruing therefrom under 35 U.S.C. 119, the contents of which in its entirety are herein incorporated by reference.

### FIELD

The present disclosure relates to a multi-signature-based digital asset management method and device, and more particularly, to a digital asset management method capable of safely storing a cryptographic key and, in the event of a loss of the cryptographic key, efficiently recovering the cryptographic key, and a device implementing the method.

### BACKGROUND

A digital asset exists in binary format and represent something that comes with the right to be used. Data without a right to be used is not considered an asset. The digital asset includes digital documents, audio or video contents like music or movies, as well as other relevant digital data currently in circulation or storable on digital devices. However, the digital assets are not limited thereto.

In the traditional sense, the digital asset is an abstract term that refers to tangible or virtual collections such as virtual machines, servers, applications, data, and the like, similar to physical assets. However, with the emergence of the blockchain and fintech markets, the meaning of digital asset has changed significantly. The blockchain and fintech industries use the term “digital assets” to refer cryptocurrencies as well as the traditional meaning.

The cryptocurrencies are a form of digital currencies created using cryptographic techniques. The cryptocurrencies are utilized in the form of encrypted data within interconnected internet networks. Since the cryptocurrencies exist solely as digital data without physical form, the cryptocurrencies are also referred to as virtual money. The cryptocurrencies are often referred to as crypto assets because they are frequently used for secure asset storage rather than being used primarily as a means of payment.

Most cryptocurrencies utilize decentralized peer-to-peer (P2P) blockchain technology for storing and transmitting values. Cryptocurrency is a form of digital currency created using cryptographic techniques, utilizing hashing technology to create electronic money. It is characterized by controlled money supply (based on the gold standard), decentralization without the need for a central bank, and the use of a distributed ledger system to ensure the reliability and stability of transactions. Cryptocurrencies function as global currencies unrestricted by any specific nation's regulations, akin to a form of digital gold.

Due to its decentralized nature, the cryptocurrencies exist on the blockchain, and owners of the cryptocurrencies can store cryptographic keys that allow the owners to transact their owned cryptocurrencies within a digital wallet.

However, storing the cryptographic keys that allow individuals to manage cryptocurrencies carries the risk of hacking, loss, or damage. For this reason, there are many cases where intermediaries like exchanges store individuals' cryptographic keys. Nevertheless, even though the exchanges manage private keys, if there are issues with the trustworthiness of the exchange, the cryptocurrencies cannot be safely managed anymore. Instances have been reported where representatives of exchanges abroad have misappropriated customers' cryptocurrencies.

In addition, there is a critical issue where the loss of a private key, such as one stored in an electronic wallet, can lead to the loss of the cryptocurrency itself.

As a technique related to the present disclosure, Korean Patent No. 10-2377987 discloses a system for restoring a lost private key. This related technology involves generating a master key, converting the master key into a cryptographic key, generating partial cryptographic keys by dividing the cryptographic key into multiple parts, encrypting the partial cryptographic keys, and restoring a lost key using the partial cryptographic keys. In this context, the present disclosure is different from the related technology in that the present disclosure relates to multi-factor authentication using multiple cryptographic keys based on a smart contract and distributed storage of cryptographic keys.

### RELATED DOCUMENT

### Patent Document

(Patent Document 0001) Korean Patent No. 10-2377987 (Published on Mar. 22, 2022)

### SUMMARY

The present disclosure provides a device and method for managing a transaction of digital assets based on a smart contract.

The present disclosure also provides a device and method for managing digital assets through multi-factor authentication based on a smart contract.

The present disclosure also provides a device and method for seeking compensation for damage caused to digital assets through an insurance contract concluded for the digital assets.

The present disclosure also provides a device and method for continuously using a smart contract through a new private key when the private key used in the smart contract is lost.

In one aspect of the present disclosure, there is provided a digital asset management method performed by a digital asset management device, the method including: concluding, by a first terminal corresponding to the digital asset management device, a contract regarding a digital asset management service between a user, a service provider of the digital asset management service, and a third party through online connections; creating a contract account based on the contract; and registering a party account corresponding to the first terminal among party accounts, which are created based on cryptographic keys managed by the first, second, and third terminals, onto the contract account.

The contract may be based on a smart contract designed to automatically execute contract contents when a pre-defined contract requirement is met.

The contract may include a requirement of subscribing to insurance with digital assets as goods insured.

The third party may be at least one of an insurance company of the insurance, a reputable public institution, and a private institution.

The cryptographic keys may include a first cryptographic key generated by the first terminal, a second cryptographic key generated by the second terminal, and a third cryptographic key generated by the third terminal.

When the contract requirement is met, a transaction regarding the digital assets of the user may be performed upon execution of a code defined in the smart contract.

The digital asset management method may further include: in response to the first cryptographic key being managed by the first terminal, processing a transaction regarding the digital assets based on multi-signature that utilizes a majority of cryptographic keys among the first cryptographic key, the second cryptographic key, and the third cryptographic key.

The digital asset management method may further include: in response to the first cryptographic key being lost, processing a loss of the first cryptographic key.

The processing of the loss of the first cryptographic key may include: creating a new party account of the user based on a new first cryptographic key; and re-registering the newly created party account onto the contract account through authentication of the second terminal and the third terminal.

The digital asset management method may further include: in an event of a succession of the user's status, authenticating a successor of the user's status from at least one of the second terminal and the third terminal in accordance with provisions of the smart contract.

The digital asset management method may further include: in response to the user incurring damage caused to the digital assets that are the goods insured, seeking compensation for the damage from the third party through the third terminal.

The creating of the party account may include: selecting a mnemonic from a dictionary; generating a private key among the cryptographic keys by using the mnemonic; generating a public key among the cryptographic keys by using a private key; and creating the party account by using the public key.

In another aspect of the present disclosure, there is provided a multi-signature-based digital asset management device including: a contract concluding unit configured to process a contract regarding a digital asset management service between a user, a service provider of the digital asset management service, and a third party by accessing a second terminal of the service terminal and a third terminal of the third party online; an account creating unit configured to create a contract account; an account registering unit configured to register a party account, created based on a cryptographic key managed by the user, onto the contract account; and a communication unit configured to perform communication with the second terminal and the third terminal.

The details of other embodiments are included in the “DESCRIPTION OF EXEMPLARY EMBODIMENTS” and the accompanying “DRAWINGS”.

Advantages and/or features of the present disclosure, and methods of achieving them, will become apparent with reference to the various embodiments described below in detail in conjunction with the accompanying drawings.

However, the following should be understood. The present disclosure is not limited as only configuration of each example to be disclosed hereinafter but may be realized in different and various forms. Each example disclosed in this specification is merely for completing the present disclosure, and is provided for completely inform those skilled in the art of a category of the present disclosure. The present disclosure is defined by only a category of each claim in the scope of claims.

According to the present disclosure, it is possible to safely manage a cryptocurrency transaction based on a smart contract.

In addition, it is possible to reduce the risk of cryptocurrency loss through multi-factor authentication based on a smart contract.

In addition, by subscribing to an insurance that covers cryptocurrencies as the goods insured, it is possible to seek compensation for a cryptocurrency loss resulting from carelessness in handling.

### BRIEF DESCRIPTION OF THE DRAWINGS

FIG. 1 is an exemplary diagram of a digital asset management device and a network according to an embodiment of the present disclosure.

FIG. 2 is an exemplary diagram of blockchain nodes according to an embodiment of the present disclosure.

FIG. 3 is an exemplary diagram of a block of a blockchain according to an embodiment of the present disclosure.

FIG. 4 is a block diagram of a digital asset management device according to an embodiment of the present disclosure.

FIG. 5 is an exemplary view of contract execution between parties according to an embodiment of the present disclosure.

FIG. 6 is a flowchart of a multi-signature-based digital asset management method according to an embodiment of the present disclosure.

FIG. 7 is a flowchart of a multi-signature-based digital asset management method according to an embodiment of the present disclosure.

### DETAILED DESCRIPTION

Before describing the preset disclosure specifically, the following should be understood. The terms or words used in this specification should not be construed to be limited as a conventional or lexical meaning but an inventor of the present disclosure may properly define and use concepts of various terms to describe his/her invention in the best method. Furthermore, these terms or words should be construed as the meaning and concept corresponding to the technical spirit of the present disclosure.

In other words, the term used in this specification is merely used for describing a preferable example of the present disclosure, and is not used with intent of specifically limiting the content of the present disclosure. These terms are the terms defined under consideration of various possibilities of the present disclosure.

In addition, it should be noted that in this specification, a singular expression used in this specification may include a plural expression as long as the expression is not definitely differently indicated in the context. Similarly, even if there is the plural expression, the expression may include the singular meaning.

Throughout a whole of this specification, when there is the description that any component “includes” another component, it may mean that any different component is not excluded but the any different component may be further included as long as there is no description particularly opposite to the above.

Furthermore, when there is the description that any component “exists in an inside of another component, or is connected thereto and is installed therein”, this component may be directly coupled to another component, be connected thereto and is installed therein, or be spaced apart from the same by a certain distance and installed therein. With respect to the case of being spaced apart from the same by the certain distance and installed therein, the following should be understood. There may be a third component or means for fixing and connecting the relevant component to another component. The description of the third component or means may be omitted.

On the contrary, it should be understood that when there is the description that any component is “directly coupled”, or “directly connected” to another component, there is no third component or means.

Similarly, other expressions describing a relation of each component, that is, “^{˜}between” and “directly ^{˜}between”, or “neighboring ^{˜}” and “directly neighboring”, etc. should be construed to have the same intent.

Also, if the terms such as “one surface”, “another surface”, “one side”, “another side”, “first”, and “second” are used in this specification, the following should be understood. The terms are used with respect to one component so as to distinguish this one component from another component, wherein the terms are not used in order that the meaning of the relevant component is limited by the terms as the above.

Also, if the terms related to positions such as “upper”, “lower”, “left”, and “right” are used in this specification, it should be understood that the terms represent relative positions in the relevant drawing with respect to the relevant component. As long as absolute positions with respect to these positions are not specified, the terms related to these positions should not be understood as referring to absolute positions.

Also, in this specification, when a reference numeral is described with respect to each component of each drawing, an identical component has an identical reference numeral even if this component is presented in other drawings. That is, throughout the whole of specification, identical reference numerals denote identical components.

A size, a position, a combination relation, etc. of each component configuring the present disclosure in the attached drawings of the present disclosure may be described to be partially exaggerated, minimized, or omitted so as to sufficiently and clearly deliver the spirit of the present disclosure or for convenience of the description. Therefore, their proportion or scale may not be precise.

Also, in describing the present disclosure, configuration, for example, the detailed description of known technologies including conventional technologies may be omitted if it is deemed to make the gist of the present disclosure unnecessarily vague.

Hereinafter, embodiments of the present invention will be described in detail with reference to related drawings.

In the present disclosure, digital assets are concepts that include cryptocurrencies, non-fungible tokens (NFTs), and binary data files created such as illustrations, animations, and audio-visual media.

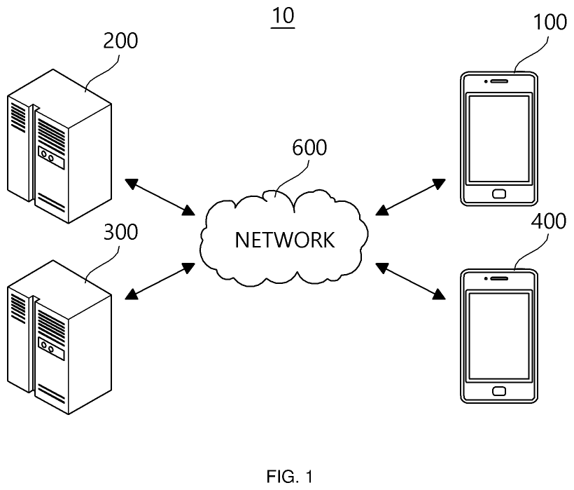

FIG. 1 is an exemplary diagram of a digital asset management device and a network according to an embodiment of the present disclosure.

Referring to FIG. 1, there are illustrated a multi-signature-based digital asset management device (hereinafter referred to as a “digital asset management device”), a second terminal of a service provider 200, a third terminal 300 of a third party, a fourth terminal 400 of a recipient, and a network 600 interconnecting them. The digital asset management device 100 will be referred to as a user's first terminal in relation to the second terminal 200 and the third terminal 300.

The user refers to an individual or corporation utilizing a digital asset management service, and the service provider may provide the digital asset management service to the user. The user and the service provide are parties to a digital asset management contract. The recipient corresponds to the counterparty of a sender, who is the user, in a transaction.

In addition, the user and the third party are parties to an insurance contract with digital assets as the goods insured. The two contracts, namely a digital asset management contract and the digital asset insurance contract, may each be independent contracts or may be a combined contract. Thus, the user, the service provider, and the third party may conclude the digital asset management contract regarding the management and insurance of the digital assets owned by the user.

The digital asset management contract may be concluded in a digital manner. For example, the digital asset management contract may be concluded based on a smart contract. The smart contract is a system in which contents agreed upon by the contract parties are pre-programmed and stored in an electronic contract document, and the contract contents are automatically executed when a requirement of the contract is met. While the existing blockchain 1.0 records events that occurred in the past, blockchain 2.0 implementing a smart contract function may record in advance events that will take place in the future. The smart contract is defined as a computerized transaction contract that executes the necessary elements of a contract by itself through a code.

According to an embodiment of the present disclosure, the smart contract may involve the user, the service provider, and the third party as contract parties, and may be concluded by accessing the first terminal 100, the second terminal 200, and the third terminal 300 online. The concluded smart contract may be recorded in a block 511 within a plurality of blockchain nodes 501 constituting a blockchain platform 500.

The digital asset management device 100 corresponding to the first terminal may handle conclusion of the smart contract with the second terminal 200 and the third terminal 300 online, and execute a transaction based on the smart contract. In other words, based on the fulfillment of a contract requirement predefined in the smart contract, the contract contents may be executed. For example, as the contract requirement for executing a transaction is met when signatures from a majority of the contract parties are obtained, a transaction regarding the user's digital assets may be performed through automatic execution of a code defined in the smart contract. Here, the transaction may refer to any of various events that lead to a change in the digital assets, such as remittance of cryptocurrency.

The second terminal 200 corresponds to a terminal owned by the service provider, which is one of the parties to the smart contract.

The third terminal 300 corresponds to a terminal owned by the third party, which is one of the parties to the smart contract. Here, the third party may include an insurance company, a reputable public institution, or a private organization.

The fourth terminal 400 corresponds to a terminal of a recipient involved in a transaction executed by the first terminal 100, such as the recipient of remitted cryptocurrency.

The network 600 includes any suitable communication network, including wired and wireless networks, such as serial communication, a local area network (LAN), a wide area network (WAN), Intranet, and Extranet, and mobile networks, such as cellular, 3G, LTE, 5G, WiFi network, ad hoc network, and combinations thereof.

The network 600 may include connections of network elements such as hubs, bridges, routers, switches, and gateways. The network 600 may include one or more connected networks, for example, a multi-network environment, including a public network such as an internet and a private network such as a safe corporate private network. The access to the network 600 may be provided via one or more wired or wireless access networks.

The digital asset management method according to an embodiment of the present disclosure, and the digital asset management device 100 utilizing the same are characterized by being based on a blockchain 510. Hereinafter, the block chain 510 will be described.

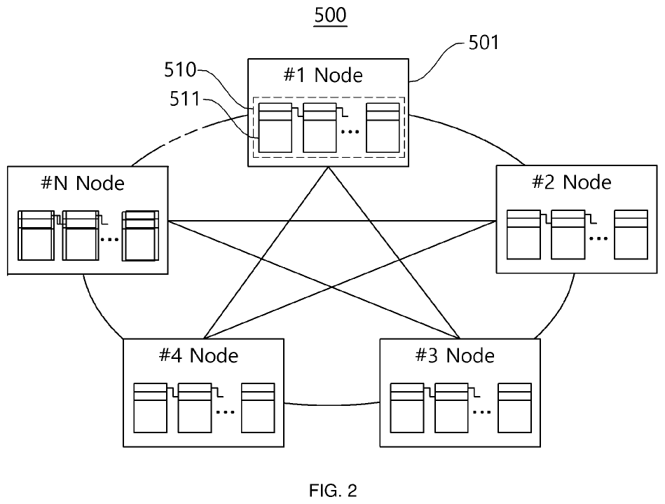

FIG. 2 is an exemplary diagram of blockchain nodes according to an embodiment of the present disclosure.

Referring to FIG. 2, one blockchain platform 500 among a plurality of blockchain platforms utilizing the network 600 is illustrated. The blockchain platform 500 may be composed of a plurality of blockchain nodes 501 (#1 Node to #N Node).

The blockchain node 501 is a type of computer capable of processing, transmitting, receiving, and storing data, and includes a blockchain 510. The blockchain 510 is a form of data stored in a storage device, and corresponds to a digital distributed ledger. The blockchain 510 takes the form of multiple blocks 511 linked together in a chain, and each block 511 may store a smart contract according to an embodiment of the present disclosure and a transaction executed by the smart contract.

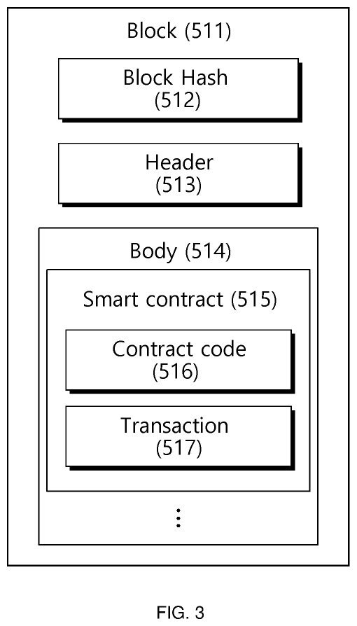

FIG. 3 is an exemplary diagram of a block of a blockchain according to an embodiment of the present disclosure.

Referring to FIG. 3, the block 511 included in the block chain 510 is illustrated. The block 511 may include a block hash 512, a header 513, and a body 514. The body 514 may include a smart contract 515. In addition, the smart contract 515 may include a contract code 516 and a transaction 517.

The block hash 512 is a representative value that represents a block as a single value, and serves as a criterion for identifying the corresponding block within a blockchain composed of numerous blocks.

The header 513 includes summarized information on transactions and block-related information.

The body 514 is where transactions, i.e., transaction details, are stored.

In the block structure, the three components—block hash, header, and body—do not exist independently. Instead, all information on the body is summarized and included in the header, and the block hash represents all information on the header as a single value.

Included in the body of the block, the smart contract 515 includes a predefined contract requirement and contract contents in the contract code 516. When the contract requirement is met, a transaction corresponding to the contract contents may be executed. In other words, the contract code 516 is where the contract requirement and the contract contents are defined. Hereinafter, the digital asset management device 100 according to an embodiment of the present disclosure will be described.

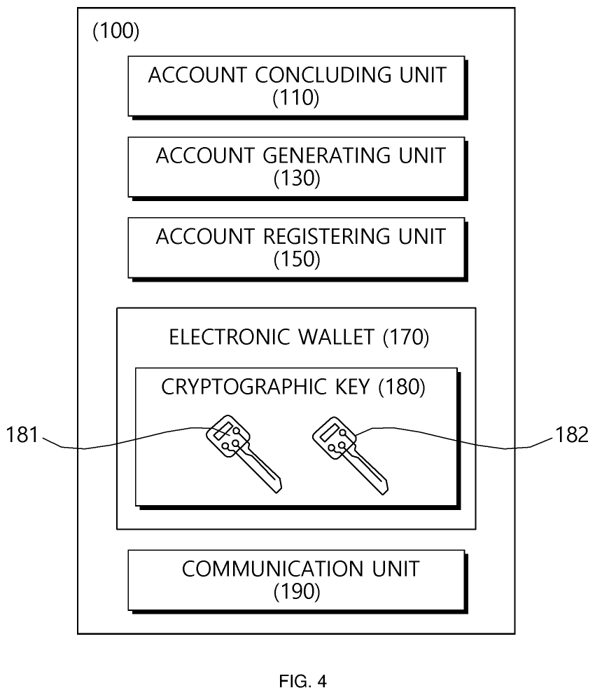

FIG. 4 is a block diagram of a digital asset management device according to an embodiment of the present disclosure.

Referring to FIG. 4, the digital asset management device 100 may include a contract concluding unit 110, an account creating unit 130, an account registering unit 150, an electronic wallet 170, and a communication unit 190.

The contract concluding unit 110 may process conclusion of a contract regarding a digital asset management service among a user, a digital asset management service provider, and a third party. To conclude the contract, the digital asset management device 100 corresponding to the first terminal, the second terminal 200, and the third terminal 300 may transmit and receive data through online connection. The contract requirement derived from a contract between contract parties, along with the corresponding terms, are written in an executable code form, and the contract may be concluded in such a way that the contract parties sign the contract using their cryptographic keys.

The account creating unit 130 may create a contract account based on the contract between the three parties. The contract account corresponds to an account jointly managed by the contract parties. The contract account may include an address of a contract existing on a blockchain, for example, a smart contract.

The account registering unit 150 may register a party account, created based on a cryptographic key managed by the user, onto the contract account. Each contract party may possess his or her own cryptographic key, and a party account created based on his or her own cryptographic key. As each party account is registered onto the contract account, information on a corresponding party account may be recorded in the contract account. Based on the information recorded in the contract account, for example, information on party accounts and information on the contract, a transaction utilizing cryptographic keys of registered party accounts is signed as per the contract requirement. As a result of the signing, the contract contents, for example, the corresponding transaction, may be executed.

The electronic wallet 170 may store cryptographic keys of party accounts. That is, among the contract parties, the user may create the electronic wallet 170 in the digital asset management device 100 or an external device connected thereto, and store and manage cryptographic keys 180. Similarly, the service provider may store and manage a second cryptographic key 2 through the second terminal 200, and the third terminal may store and manage a third cryptographic key 3 through the third terminal 300.

The cryptographic keys 180 may include a first cryptographic key 181, corresponding to a private key, and a public key 182. The first cryptographic key 181 corresponds to an individual's digital signature and may be used to prove the identity of a party who is conducting a transaction or sending a message. For reference, the second terminal 200 may manage the second cryptographic key 2, and the third terminal 300 may manage the third cryptographic key 3.

The communication unit 190 serves to allow the digital asset management device 100 to access online the second terminal 200 and the third terminal 300 through the network 600.

Hereinafter, a contract between contract parties, for example, a transaction executable based on a smart contract will be described.

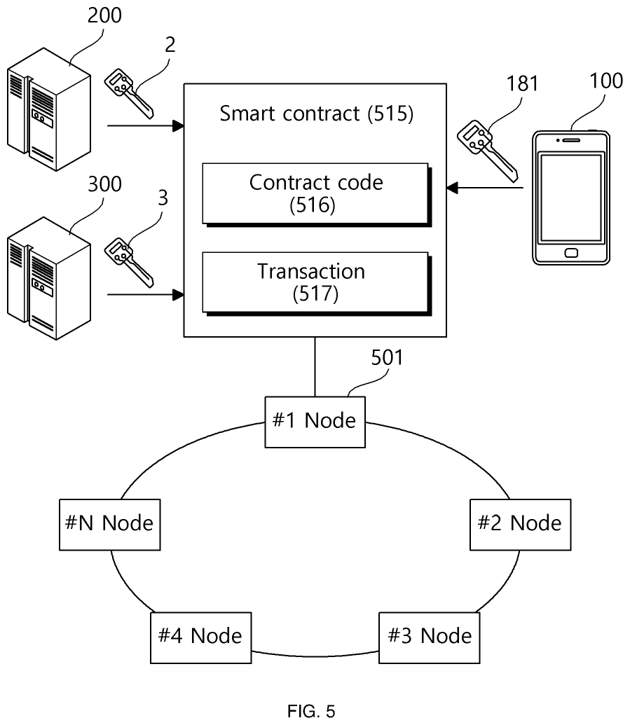

FIG. 5 is an exemplary view of contract execution between parties according to an embodiment of the present disclosure.

Referring to FIG. 5, a user's digital asset management device 100, a service provider's second terminal 200, and a third party's third terminal 300 may sign using cryptographic keys to execute a transaction according to a predefined contract. The signing may be performed in various ways. For example, there may be cases where signing is possible using only one of the cryptographic keys from a set of cryptographic keys 180, specifically the first cryptographic key 181 corresponding to the private key, where signing requires not just the first cryptographic key 181, but either the second cryptographic key 2 corresponding to the service provider's private key or the third cryptographic key 3 corresponding to a third party's private key, and where signing requires all of the first cryptographic key 181, the second cryptographic key 2, and the third cryptographic key 3.

When the contract requirement is met through signing using at least the first cryptographic key 181, the transaction 517 may be performed by executing the contract code 516 of the contract contents.

The smart contract 515 may include the contract requirement and the contract contents. Also, since the contract requirement and the contract contents are pre-defined, the smart contract 515 is designed to execute the contract code 516 corresponding to the contract contents when the contract requirement is met.

When a transaction is performed upon the execution of the contract code 516, details of the transaction are recorded in the body of the corresponding block on the blockchain.

The transaction 517 involves a sequence of steps in which cryptocurrency is transferred between the user and the recipient. This occurs between the digital asset management device 100 corresponding to the first terminal, and the fourth terminal 400 of the recipient. The process uses the public addresses of the user and the recipient, which are inputs and outputs of the cryptocurrency UTXO transaction model.

Hereinafter, a digital asset management method S100 according to an embodiment of the present disclosure performed by the digital asset management device 100 will be described.

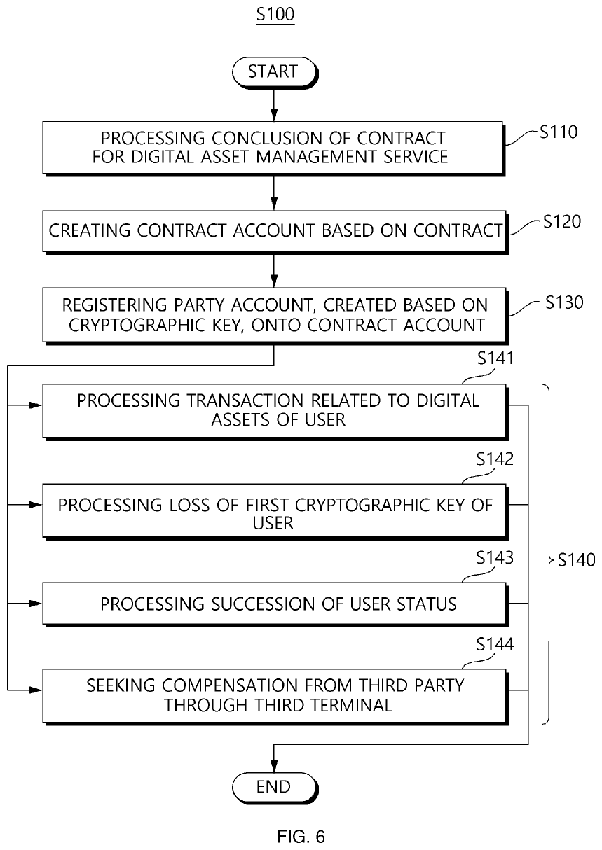

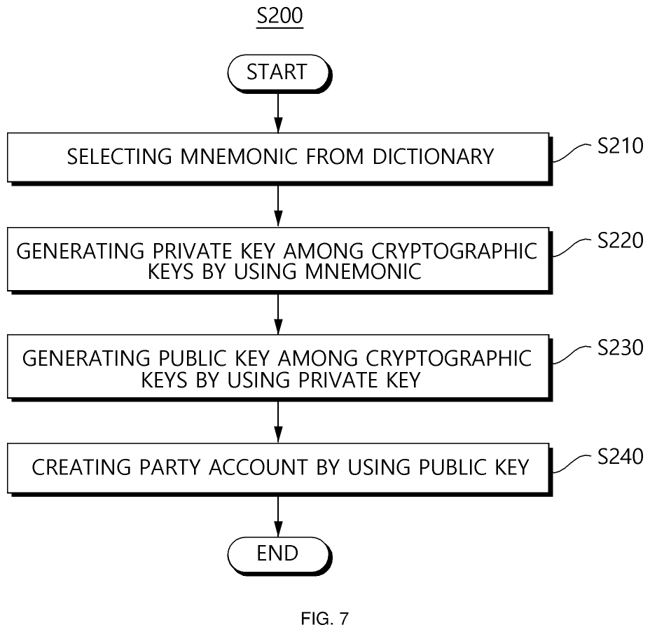

Digital asset management may be performed by the digital asset management system 10 including the digital asset management device 100 corresponding to the first terminal, the second terminal 200, and the third terminal 300. However, the digital asset management method S100 of FIGS. 6 and 7 is illustrated from the perspective of the digital asset management device 100 to show a consistent flow from the perspective of a user.

That is, FIGS. 6 and 7 show events that take place at the front-end of the system 10 used by the user, that is, the digital asset management system 10 which includes the first terminal 100, the second terminal 200, the third terminal 300, and the network 600. In addition, at the back-end behind the front-end, the second terminal 200 and the third terminal 300 may take the lead to perform events associated with the aforementioned events.

FIG. 6 is a flowchart of a multi-signature-based digital asset management method according to an embodiment of the present disclosure.

Referring to FIG. 6, the digital asset management method S100 according to an embodiment of the present disclosure may include: processing conclusion of a contract regarding a digital asset management service in operation S110l, creating a contract account based on the contract in operation S120l, registering a party account created based on a cryptographic key onto the contract account in operation S130l, and processing various events in operations S141, S142, S143, and S144.

First, the digital asset management device 100 may process conclusion of a contract regarding a digital asset management service in operation S110l. For example, the digital asset management device 100 and the third terminal 300 of the third party may conclude a contract between three parties by accessing online the second terminal 200 of the service provider that corresponds to a server. Here, the contract between the three parties may be based on a smart contract designed to execute contract contents when a predefined contract requirement is met.

The contract between the three parties may include a requirement of subscribing to insurance for digital assets owned by the user, for example, cryptocurrency as the goods insured. That is, the contract may include a contract concerning the management of digital assets between the user and the service provider, and a contract regarding the preservation of digital assets between the user and a third party.

The third party may include an insurance company, a reputable public institution, or a private organization. Also, the third party may be plural.

Next, the digital asset management device 100 may create a contract account based on the tri-party contract in operation S120l. Here, the contract may be an online contract based on a smart contract. The smart contract used in the present disclosure may include all or part of the definitions and structures of the smart contract proposed by Nick Szabo, or Ethereum smart contract implemented by Vitalik Buterin.

Next, the digital asset management device 100 may register a party account created based on cryptographic keys 180 in the contract account in operation S130l. The cryptographic keys 180 may include a first cryptographic key 181 and a public key 182 corresponding to a private key. The first cryptographic key 181 may be used for registration of the party account.

Even for the second terminal 200 and the third terminal 300, a party account may be registered into the contract account in the same way. That is, the second terminal 200 may register a second party account created based on the second cryptographic key to the contract account. The third terminal 300 may register a third party account created based on the third cryptographic key to the contract account.

That is, the three parties (the user, the service provider, and the third party) use their cryptographic keys (the first cryptographic key, the second cryptographic key, and the third cryptographic key) to create their own party accounts (the first party account, the second party, and the third party account), respectively.

Hereinafter, operation S200 of creating a party account by the digital asset management device 100 will be described.

FIG. 7 is a flowchart of a multi-signature-based digital asset management method according to an embodiment of the present disclosure.

In the digital asset management method in operation S200 illustrated in FIG. 7, there is illustrated how to create the user's first cryptographic key 181 among the cryptographic keys 180 necessary for operation S130 of registering a party account onto the contract account. The second cryptographic key 2 owned by the service provider and the third cryptographic key 3 owned by the third party may be generated by the second terminal 200 and the third terminal 300, respectively.

First, the digital asset management device 100 may select a mnemonic from a dictionary through the account registering unit 150 in operation S210. Next, the first cryptographic key 181 corresponding to a private key among the cryptographic keys 180 may be generated using the mnemonic in operation S220. Next, the public key 182 may be generated using the first cryptographic key 181 in operation S230. Lastly, a party account may be created using the public key 182 in operation S240. The created party account may be registered in the contract account. Similarly, the second terminal 200 may generate a second cryptographic key 2 corresponding to the private key of the service provider, a public key, and a party account. In addition, the third terminal 300 may generate a third cryptographic key 3 corresponding to a third party's private key, a public key, and a party account.

Referring back to FIG. 6, the digital asset management device 100 may process various events that take place after the conclusion of the smart contract in operation S140.

For example, the digital asset management device 100 may process a transaction regarding the user's digital assets in operation S141. When the first terminal corresponding to the digital asset management device 100 manages the first cryptographic key 181, the digital asset management device 100 may process a transaction regarding the digital assets based on multi-signature that utilizes a majority of cryptographic keys among the first cryptographic key 181, the second cryptographic key 2, and the third cryptographic key 3.

For example, the digital asset management device 100 may process a loss of the user's first cryptographic key in operation S142. When the first cryptographic key 181 under the user's management is lost, the digital asset management device 100 may process the loss of the first cryptographic key 181. That is, when the user loses the first cryptographic key 181, the user's digital asset management device 100 generates a new first cryptographic key and creates a new party account for the user based on the new first cryptographic key. Then, the second terminal 200 and the third terminal 300 may re-register the newly created party account onto the contract account through authentication. In doing so, with the new first cryptographic key, the user may be able to use the smart contract in the same way as before.

In a smart contract according to an existing technology, if individual accounts respectively generated by a user, a service provider, and a third party are registered with ownerships and the user loses his or her first cryptographic key, the user's ownership of the smart contract is forfeited.

However, in one embodiment according to the present disclosure, if the user's identity is verified through authentication by the service provider and the third party, confirming that the user is the same individual as the existing user, the user may maintain ownership of the smart contract by registering a newly created party account, which is based on a newly generated first cryptographic key, onto the existing smart contract.

Therefore, for the user, it is possible to avoid a large loss (inability to access the smart contract, loss of cryptocurrency stored in the smart contract, etc.) that can happen if the first cryptographic key (private key) is lost. The service provider may be an individual or company that provides the system of the present disclosure in the form of an app or web, and the third party may be an insurance company, a reputable public institution, or a private organization that provides assurance or guarantee for the credibility of a service provided by the service provider. With the aforementioned service, the present disclosure may prevent various types of damage that may occur when a private key is lost.

In another embodiment, when there is a succession to the user's status in operation S143, the digital asset management device 100 may process the succession to the user's status.

If a succession of the user's status occurs, the digital asset management device 100 may authenticate the successor of the user's status from at least one terminal, which is either the second terminal 200 or the third terminal 300, in accordance with the provisions of the smart contract. The authorized successor, through the first terminal or a terminal possessed by the successor, generates a new first cryptographic key and creates a party account using the new first cryptographic key. Then, the successor registers the successor's party account onto the smart contract, thereby enabled to participate as a contractual party of the smart contract in the role of the user's successor. Here, the concept of succession may include historical succession, specific succession, comprehensive succession, and designated succession.

In another embodiment, the digital asset management device 100 may, through the third terminal, seek compensation for damage caused to digital asset management from the third party in operation S144.

If such a claim for compensation for damage is incorporated into the smart contract, in the event that the user incurs a loss of the insured digital assets, the digital asset management device 100 may seek compensation for the loss from the third party through the third terminal 300. The third party corresponds to the custodian of the third cryptographic key 3 and serves as a contract party in the contract regarding digital asset management between the involved parties based on the third cryptographic key 3. In the present disclosure, the insurance company acts as the third party. Thus, pursuant to the insurance contract included in digital asset management, the third party may be responsible for compensating for losses incurred in digital assets.

As such, according to an embodiment of the present disclosure, it is possible to safely manage a cryptocurrency transaction based on a smart contract.

In addition, it is possible to reduce the risk of cryptocurrency loss through multi-factor authentication based on a smart contract.

In addition, by subscribing to an insurance that covers cryptocurrencies as the goods insured, it is possible to seek compensation for a cryptocurrency loss resulting from carelessness in handling.

As described above, although exemplary embodiments of the present disclosure have been described, various embodiments disclosed in “DETAILED DESCRIPTION OF THE INVENTION” are provided only for the illustrative purpose. Those skilled in the art can understand that various modifications, variations, and equivalents of the present disclosure are possible based on the above description.

In addition, since the present disclosure can be realized in various forms, the present disclosure is not limited to the above embodiments. The above description is provided only to allow those skilled in the art to perfectly understand the scope of the present disclosure, and those skilled in the art should know that the present disclosure is defined by the appended claims.

What is claimed is:

1. A digital asset management method performed by a digital asset management device, the method comprising:
concluding, by a first terminal corresponding to the digital asset management device, processing conclusion of a contract regarding a digital asset management service between a user, a service provider of the digital asset management service, and a third party through online connections;
creating a contract account based on the contract; and
registering a party account corresponding to the first terminal among party accounts, which are created based on cryptographic keys managed by the first, second, and third terminals, onto the contract account.

2. The digital asset management method of claim 1, wherein the contract is based on a smart contract designed to automatically execute contract contents when a pre-defined contract requirement is met.

3. The digital asset management method of claim 1, wherein the contract comprises a requirement of subscribing to insurance with digital assets as goods insured.

4. The digital asset management method of claim 3, wherein the third party is at least one of an insurance company of the insurance, a reputable public institution, and a private institution.

5. The digital asset management method according to claim 3, wherein the cryptographic keys comprise a first cryptographic key generated by the first terminal, a second cryptographic key generated by the second terminal, and a third cryptographic key generated by the third terminal.

6. The digital asset management method of claim 5, wherein when the contract requirement is met, a transaction regarding the digital assets of the user is performed upon execution of a code defined in the smart contract.

7. The digital asset management method of claim 6, further comprising:
in response to the first cryptographic key being managed by the first terminal, processing a transaction regarding the digital assets based on multi-signature that utilizes a majority of cryptographic keys among the first cryptographic key, the second cryptographic key, and the third cryptographic key.

8. The digital asset management method of claim 5, further comprising: in response to the first cryptographic key being lost, processing a loss of the first cryptographic key.

9. The digital asset management method of claim 8, wherein the processing of the loss of the first cryptographic key comprises:
creating a new party account of the user based on a new first cryptographic key; and
re-registering the newly created party account onto the contract account through authentication of the second terminal and the third terminal.

10. The digital asset management method of claim 5, further comprising:
in an event of a succession of the user's status, authenticating a successor of the user's status from at least one of the second terminal and the third terminal in accordance with provisions of the smart contract.

11. The digital asset management method of claim 8, further comprising:
in response to the user incurring damage caused to the digital assets that are the goods insured, seeking compensation for the damage from the third party through the third terminal.

12. The digital asset management method of claim 1, wherein the creating of the party account comprises:
selecting a mnemonic from a dictionary;
generating a private key among the cryptographic keys by using the mnemonic;
generating a public key among the cryptographic keys by using a private key; and
creating the party account by using the public key.

13. A multi-signature-based digital asset management device comprising:
a contract concluding unit configured to process a contract regarding a digital asset management service between a user, a service provider of the digital asset management service, and a third party by accessing a second terminal of the service terminal and a third terminal of the third party online;
an account creating unit configured to create a contract account;
an account registering unit configured to register a party account, created based on a cryptographic key managed by the user, onto the contract account; and
a communication unit configured to perform communication with the second terminal and the third terminal.
